(19) United States
(12) Patent Application Publication
(10) Pub. No.: US 2007/0159923 A1
(43) Pub. Date: Jul. 12, 2007

(54) Acoustic Lure Tracking System

(76) Inventor: Darrell Huff, Stevensville, MD (US)

Correspondence Address: LAUBSCHER & LAUBSCHER, P.C., 1160 SPA ROAD, SUITE 2B, ANNAPOLIS, MD, 21403, US

(21) Appl. No.: 11/619,884

(22) Filed: Jan. 4, 2007

Related U.S. Application Data
(60) Provisional application No. 60/766,269, filed on Jan. 6, 2006.

(51) Int. Cl. G01S 3/80

(52) U.S. Cl. 367/118

(57) ABSTRACT

A fishing lure tracking system includes a sending unit which sends a coded acoustic signal to a hydrophone attached to a fishing vessel to provide a signal correlating to the depth of the sending unit in a body of water. The sending unit is arranged on a fishing line adjacent to the bait or lure at the end thereof. The acoustic signal is processed by a signal processor connected with the hydrophone to produce an output signal for a display to indicate the depth of the unit. With the tracking system, a fisherman can position the lure or bait at the same depth as a school of fish.

This application claims the benefit of U.S. provisional application No. 60/766,269 filed Jan. 6, 2006.

### BACKGROUND OF THE INVENTION

A relatively recent advance for commercial and recreational fisherman has been the use of acoustic devices to detect fish beneath the water surface. Such devices, also known as fish finders, use acoustic signals to detect the location of fish relative to the bottom of the body of water and indicate the depth location on a display. Based on the fish depth information, the fisherman deploys fishing lines to approximate the depth of the fish. The present invention relates to a system used to indicate the depth of the lure or bait used on the fishing lines so that the depth of the lure may more closely align with the detected depth of the fish.

### BRIEF DESCRIPTION OF THE PRIOR ART

Miniature underwater acoustic data transmitters and receivers have been used in recent years to help biologists track the migration patterns and behavior of fish species. The transmitters are attached to a fish and propagate a coded acoustic signal through the water to a receiver that uses a hydrophone to detect the acoustic signal. The hydrophone is connected to a receiver that converts the signal to display the information in a textual or graphical format from which the biologists can determine the water depth, temperature, or other information. The receiver may either be passive to record data over time or active to receive and display data in real time.

Sensors for detecting water conditions adjacent to a fishing lure are known in the patented prior art as evidenced by the Langer U.S. Pat. No. 5,581,930. As disclosed therein, a sensor assembly is arranged in the vicinity of a lure to detect strikes and monitor lure operation as well as environmental conditions. Signals from the sensor are transmitted by a transmitter to a detector assembly above the water. The detector assembly produces an audio or video output.

Also known in the art are systems for measuring depth using a telemetering depth meter and a hydrophone for receiving signals from the meter as disclosed in the U.S. Pat. No. 3,038,143.

While the prior devices operate satisfactorily, they do not incorporate a senso/transmitter assembly that is small and lightweight enough to attach directly to a typical recreational fisherman's fishing line. Therefore, they are not designed for nor capable of determining the depth of a fishing lure in a reliable manner. The present invention was developed in order to overcome these and other drawbacks of the prior art by providing an acoustic lure tracking device which provides an indication of the depth of the lure on a deployed fishing line so that the lure can be arranged in the vicinity of fish detected beneath a fishing vessel. In addition, hydrophone based receivers currently used for detecting sonic or ultrasonic signals typically incorporate relatively large and expensive analog-to-digital signal processing units. The present invention overcomes these drawbacks by providing a low cost, low power receiver device that is affordable to recreational fishermen.

### SUMMARY OF THE INVENTION

The present invention relates to a device for determining the depth of a fishing lure or bait relative to a vessel and includes a sending unit connected with a fishing line adjacent to the lure. The sending unit preferably includes a pressure sensor for generating data as a function of the depth of the lure. In addition, the sending unit includes a transmitter which transmits the data in the form of a coded acoustic signal. A receiving unit such as a hydrophone is connected with the vessel and receives the coded acoustic signal. A signal processor is connected with the receiving unit and processes the coded acoustic signal to produce a depth signal. A display is connected with the signal processor to display the depth signal in a format which enables a fisherman to adjust the depth of the lure by letting out or reeling in the fishing line. In a preferred embodiment, the sending unit also includes a temperature sensor which generates data as a function of the ambient temperature of the water adjacent to the lure. From this data, a temperature signal is generated by the signal processor for display. If desired, a plurality of sending units may be provided on a plurality of fishing lines, respectively, each producing individually coded acoustic signals of depth and/or temperature data so that the corresponding depth and/or temperature signals for each line may be displayed.

The coded acoustic signal preferably comprises a pulse signal and the signal processor determines a characteristic thereof. The characteristic may be frequency, amplitude, pulse duration or time interval between pulses.

According to a further embodiment of the invention, a transmitter is connected with the receiver so that the depth and temperature signals may be transmitted via a wireless connection to personal or laptop computer for storage and/or display.

### BRIEF DESCRIPTION OF THE FIGURES

Other objects and advantages of the invention will become apparent through study of the following specification when viewed in the light of the accompanying drawing, in which:

FIG. 1 is a schematic illustration of the acoustic lure tracking system as used with a vessel according to the invention; and

FIG. 2 is a block diagram of the tracking system of FIG. 1.

### DETAILED DESCRIPTION

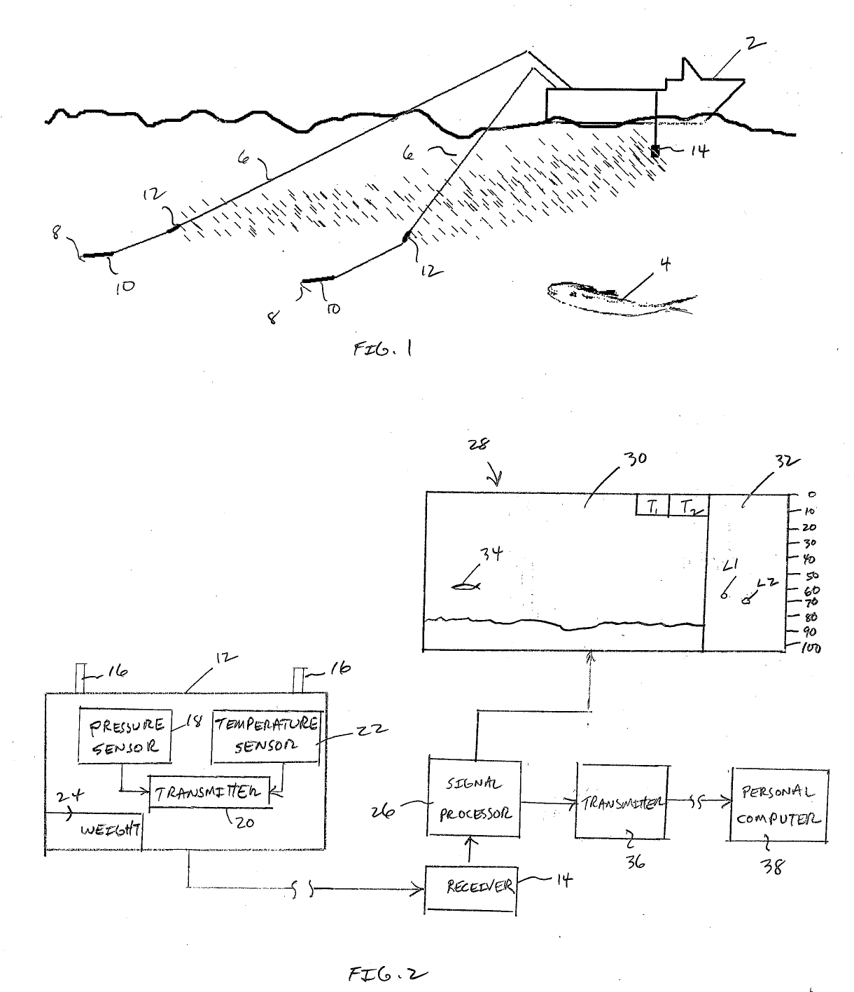

The acoustic lure tracking system according to the invention will first be described with reference to FIG. 1. As shown therein, a fishing vessel 2 is at the surface of a body of water. Beneath the surface and above the bottom of the body of water is one or more fish 4. Fishing lines 6 extend from the vessel into the water. At the end of each line is a hook 8 and a piece of bait or lure 10. Spaced a short distance from the lure is a sending unit 12 which delivers signals to a receiver 14 arranged in the water at the vessel 2.

Referring now to FIG. 2, the components of the acoustic lure tracking system will be described. The sending unit 12 includes devices 16 for connecting the unit with the fishing line. These may include hooks, clasps, eyelets or the like which preferably enable the unit to be displaced along the line in the direction of the lure but not in the direction of the vessel. In use, the sending unit is positioned adjacent to the lure in order to produce data regarding the ambient conditions thereof. More particularly, the sending unit includes a pressure sensor 18 which generates first data as a function of the depth of the unit, and thus the corresponding depth of the lure. A transmitter 20 is connected with the pressure sensor and transmits the first data to the receiver 14 in the form of a coded acoustic signal. Preferably, the sending unit also contains a temperature sensor 22 for generating second data as a function of the temperature of the water surrounding the unit. The second data is also transmitted by the transmitter 20 via the coded acoustic signal to the receiver. In addition to depth and temperature, a speed sensor may also be arranged in the sending unit to measure the speed of the unit. If desired, a weight 24 may be provided in the sending unit to assist the unit to descending toward the bottom of the body of water.

The receiver 14 preferably comprises a hydrophone which depends from the vessel. The hydrophone receives the coded acoustic signal and converts it to an electrical signal which is sent to a signal processor 26 within the vessel. The signal processor processes the coded acoustic signal to produce depth and temperature signals. These signals are in turn sent to a display 28 in the vessel which may display the signals in any conventional format such as text or graphics. For example, in the embodiment shown in FIG. 2, the display is a combination fish finder 30 and lure depth 32 display. The fish finder displays the depth of the fish beneath the vessel via a graphical fish indicator 34 as is known in the art. The lure depth display is calibrated to the fish finder display so that a graphical lure indicator L1 is shown on the display. In this manner, a fisherman can reel in or let out the lure so that it is arranged at the same depth as the fish, thereby to facilitate trolling the lure at the same depth as the fish or a school of fish. In addition, if a temperature sensor is provided in the sending unit, the temperature T1 adjacent the sending unit may be indicated on the display.

The acoustic lure tracking system according to the invention may be used with a plurality of lines. In FIGS. 1 and 2, two lines are shown. Where more than one line is used, a separate sending unit is connected with each line. The same type of data is generated by each sending unit with the acoustic signal from each unit being independently coded so that the output from each unit can be independently identified. Thus, for two units as shown in the drawing, two graphical lure indicators L1 and L2 and two temperature indicators T1 and T2 are provided.

The output signals from the signal processor 26 may utilized in a variety of ways. In addition to the display on the display 28, the signals may be sent to a transmitter 36 which transmits the signals via a wireless connection to a personal computer 38 for storage in a memory or display on the computer monitor. The computer may be a handheld PC or a laptop.

While the signal processor 26 is shown in the drawing as a separate element, it will be appreciated that it may be incorporated into the display device 28 as is known in the art.

The acoustic transmitter of the sending unit is a compact yet powerful lightweight device. It includes an internal battery with a long life because the transmitter operates at low power. The receiver is also small and lightweight. The hydrophone is preferably arranged in a cone-shaped housing (not shown) that concentrates the acoustic signal.

While the preferred forms and embodiments of the invention have been illustrated and described, it will be apparent to those of ordinary skill in the art that various changes and modifications may be made without deviating from the inventive concepts set forth above.

What is claimed is:

1. Apparatus for determining the depth of a fishing lure relative to a vessel, comprising
(a) a sending unit connected with a fishing line adjacent to the lure, said sending unit including a pressure sensor for generating first data as a function of the depth of the lure and a transmitter connected with said pressure sensor for transmitting said first data in the form of a coded acoustic signal;
(b) a receiving unit connected with the vessel for receiving said coded acoustic signal;
(c) a signal processor connected with said receiving unit for processing said coded acoustic signal to produce a depth signal; and
(d) a display connected with said signal processor for displaying said depth signal, whereby a fisherman can view the display and adjust the depth of the lure by letting out or reeling in the fishing line.

2. Apparatus as defined in claim 1, wherein said sending unit further includes a temperature sensor connected with said transmitter for generating second data as a function of the temperature of the water surrounding said unit, said second data being transmitted with said first data in the coded acoustic signal.

3. Apparatus as defined in claim 2, wherein said signal processor further processes said coded acoustic signal to produce a temperature signal and wherein said display displays said temperature signal.

4. Apparatus as defined in claim 3, wherein a plurality of sending units are provided, each connected with a separate fishing line to produce a plurality of differently coded acoustic signals, whereby depth and temperature information for the lure of each line may be displayed on the display.

5. Apparatus as defined in claim 1, wherein said receiving unit comprises a hydrophone.

6. Apparatus as defined in claim 1, wherein said coded acoustic signal comprises a pulse signal.

7. Apparatus as defined in claim 6, wherein said signal processor determines a characteristic of said coded acoustic signal.

8. Apparatus as defined in claim 7, wherein said coded acoustic signal characteristic comprises at least one of frequency, amplitude, duration, and a time interval.

9. Apparatus as defined in claim 3, and further comprising a transmitter connected with said receiver for transmitting said depth and temperature signals to a personal computer via a wireless connection.
